(19) United States
(12) Patent Application Publication
(10) Pub. No.: US 2022/0176372 A1
(43) Pub. Date: Jun. 9, 2022

(54) CARTRIDGE FOR BIOREACTOR

(71) Applicant: GENEREACH BIOTECHNOLOGY CORPORATION, Taichung City (TW)

(72) Inventors: Wen-Shan YANG, Taichung City (TW); Ching-Ko LIN, Taichung City (TW); Chia-Lin HSU, Taichung City (TW); Fu-Chun LI, Taichung City (TW); Pin-Hsing CHOU, Taichung City (TW); Yun-Lung TSAI, Taichung City (TW); Pei-Yu LEE, Taichung City (TW); Hsiao-Fen CHANG, Taichung City (TW)

(73) Assignee: GENEREACH BIOTECHNOLOGY CORPORATION, Taichung City (TW)

(21) Appl. No.: 17/219,246

(22) Filed: Mar. 31, 2021

(30) Foreign Application Priority Data
Dec. 9, 2020 (TW) 109143394

(51) Int. Cl. B01L 3/00

(52) U.S. Cl. CPC B01L 3/50855; B01L 2200/04

(57) ABSTRACT

A cartridge for a bioreactor adapted for accommodating a plurality of objects includes a cartridge main body defining a plurality of spaced-apart accommodating slots for respectively accommodating the objects therein. The cartridge main body includes a retaining portion extending into at least one of the accommodating slots, and adapted to retain a corresponding one of the objects in a corresponding one of the accommodating slots. The retaining portion is pushable to move resiliently in the corresponding one of the accommodating slots.

### CROSS-REFERENCE TO RELATED APPLICATION

This application claims priority to Taiwanese Patent Application No. 109143394, filed on Dec. 9, 2020.

### FIELD

The disclosure relates to a cartridge, more particularly to a cartridge for bioreactor.

### BACKGROUND

The use of biochemical reactions for medical examination such as clinical test, genetic identification, disease diagnosis, tests for animal and plant diseases and insect pests, etc., possesses the advantages of high efficiency, high accuracy, and high sensitivity. Thus, biochemical reactions are widely used in various professional fields.

In the process of biochemical reactions, various reagents are specifically selected to match consumables such as test tubes, and these consumables are packed into a cartridge to be sold as a set so that the set can be installed in an automatic machine for performing biochemical reactions. However, the existing cartridges do not have a function for retaining consumables disposed in the cartridge so that, when a gripping head of the automatic machine transfers the consumables in the cartridge and transfers the various reagents from and to the consumables in the cartridge, the consumables may be accidentally taken out of the cartridge, resulting in mechanical error, which adversely affects process of the medical examination.

### SUMMARY

Therefore, an object of the disclosure is to provide a cartridge capable of alleviating the drawbacks of the conventional cartridge for bioreactor.

According to an aspect of the disclosure, a cartridge for a bioreactor adapted for accommodating a plurality of objects therein is provided. The cartridge includes a cartridge main body having a top end and defining a plurality of accommodating slots. The accommodating slots are spaced apart from one another and are adapted for accommodating respectively the objects therein. Each of the accommodating slots has an open top end and extends along a height direction. The cartridge main body includes at least one resilient fastening member which extends along the height direction and which includes a retaining portion. The retaining portion extends into one of the accommodating slots, and is adapted to retain a corresponding one of the objects in a corresponding one of the accommodating slots. The retaining portion is pushable to move resiliently in the corresponding one of the accommodating slots.

According to another aspect of the disclosure, a cartridge for a bioreactor is provided to include a cartridge main body and a plurality of objects. The cartridge main body has a top end and defines a plurality of accommodating slots 100 that are spaced apart from one another. Each of the accommodating slots has an open top end and extends along a height direction. The cartridge main body includes at least one resilient fastening member extending along the height direction and includes a retaining portion extending into one of the accommodating slots. The objects are respectively and detachably accommodated in the accommodating slots. The retaining portion of the at least one resilient fastening member retains a corresponding one of the objects in a corresponding one of the accommodating slots, and is pushable to move resiliently in the corresponding one of the accommodating slots.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a cartridge for a bioreactor according to an embodiment of the present disclosure;

FIG. 2 is a partly exploded perspective view of the embodiment of the present disclosure;

FIG. 3 is a sectional view taken along line III-III in FIG. 1, illustrating a plurality of objects being disposed in a cartridge main body of the cartridge and a cover body covered on the cartridge main body;

FIG. 4 is a perspective view of the cartridge main body of the cartridge of the embodiment;

FIG. 5 is a schematic sectional view of the cartridge main body;

FIG. 6 is a schematic sectional view taken along line VI-VI in FIG. 1, illustrating a reactive tube being disposed in an accommodating slot of the cartridge main body;

FIG. 7 is a sectional view similar to FIG. 3, but the cover body being omitted and illustrating one of the objects being misplaced in another one of accommodating slot of the cartridge main body;

FIG. 8 is similar to FIG. 7, but illustrating two objects being misplaced in two accommodating slots that are not complementary in shape with the objects disposed therein;

FIG. 9 is a schematic view of the embodiment similar to FIG. 6, but illustrating a test tube cover being connected to a reaction tube; and

FIG. 10 is similar to FIG. 3, but illustrating disposition of the objects in the cartridge after being subjected to biochemical reaction.

### DETAILED DESCRIPTION

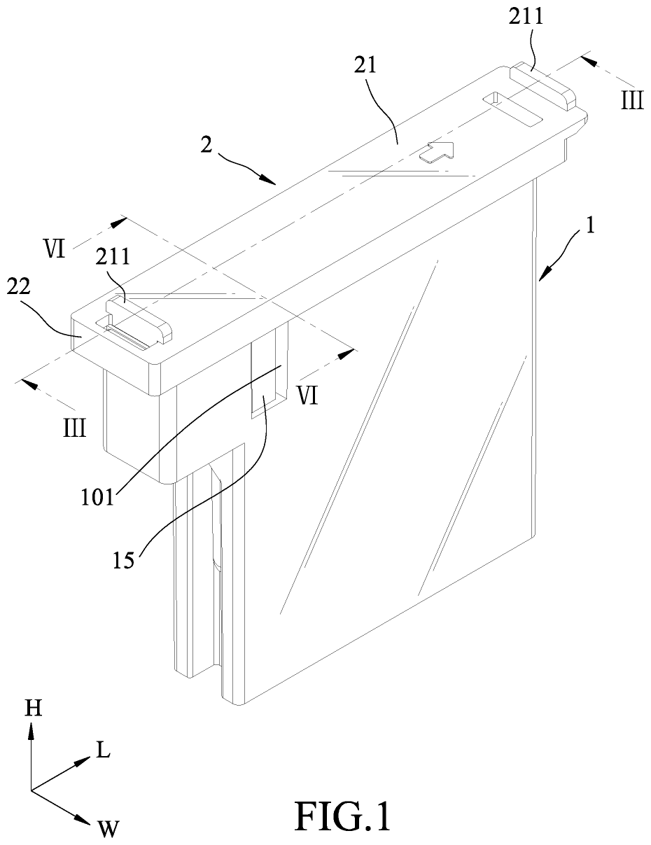

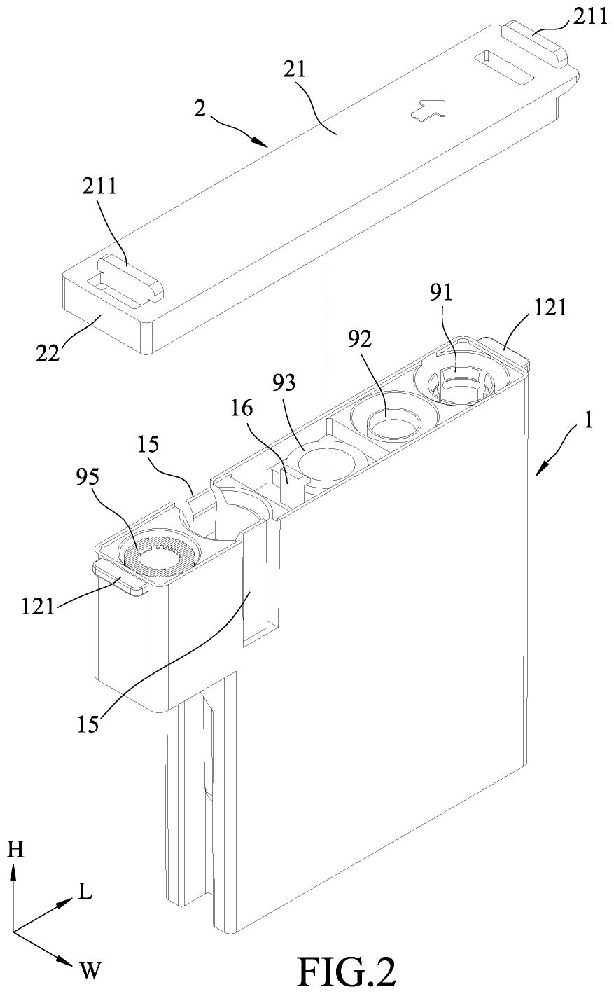

Referring to FIGS. 1 to 3, an embodiment of a cartridge for a bioreactor is adapted to be placed in a bioreactor (not shown) for performing biochemical reaction. The bioreactor includes a movable gripping head (not shown) capable of gripping an object. The cartridge for a bioreactor includes a cartridge main body 1, a plurality of objects respectively and detachably accommodated in the cartridge main body 1, and a cover body 2 detachably connected to the cartridge main body 1. The objects are provided for performing biochemical reactions, e.g., but not limited to, nucleic acid extraction. In this embodiment, the cartridge for the bioreactor is a consumable cartridge, and the objects includes a stirring sleeve 91, a steel needle 92, a reagent tube 93, a reaction tube 94, and a test tube cover 95. In other implementations, the objects may include other objects and combinations thereof. It should be appreciated that the categories and the number of the objects can be modified according to the purpose of the cartridge and the present disclosure is not limited to the specific example described herein.

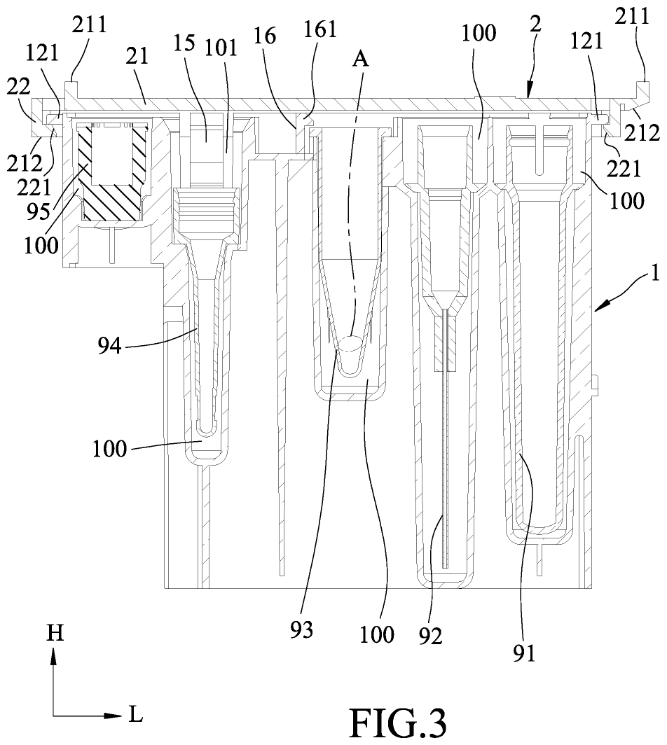

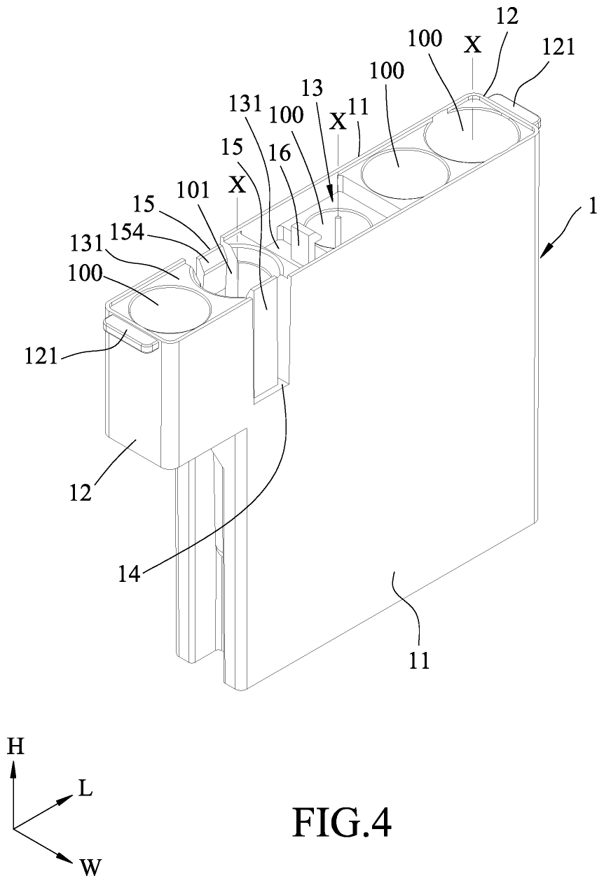

The cartridge main body 1 has a top end and defines a plurality of accommodating slots 100 spaced apart from one another and a notch 101. Each of the accommodating slots 100 surrounds an axis (X) (see FIG. 4), has an open top end, and extends along a height direction (H). The accommodating slots 100 shown in FIG. 3 from the right to the left are respectively the first, the second, the third, the fourth and the fifth accommodating slots that respectively accommodate the stirring sleeve 91, the steel needle 92, the reagent tube 93, the reaction tube 94, and the test tube cover 95 therein. The notch 101 is in spatial communication with the top end of the fourth accommodating slot 100.

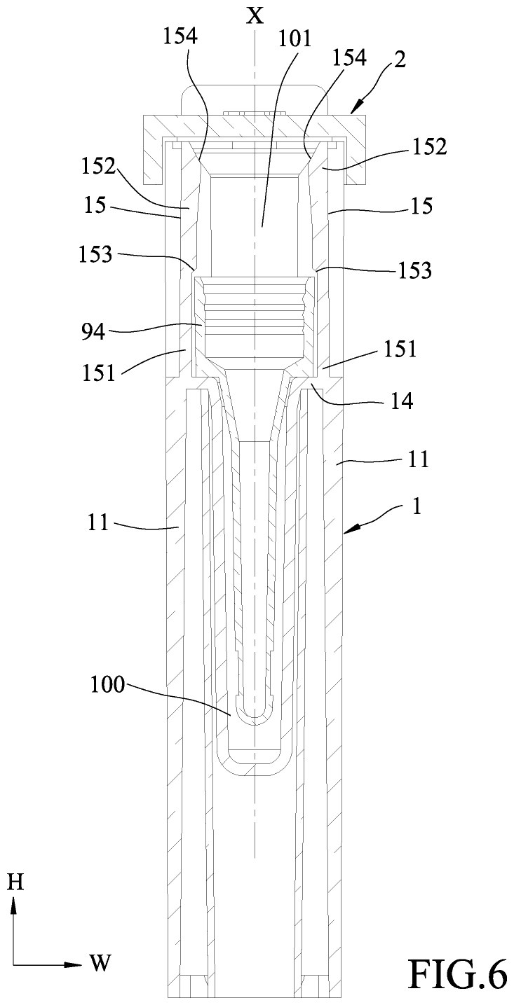

Further referring to FIGS. 4 to 6, the cartridge main body 1 includes two side walls 11, two end walls 12, a top wall unit 13, a connection wall 14, two first resilient fastening members 15, and a second resilient fastening member 16. The side walls 11 are spaced apart from each other along a width direction (W) and extend along a length direction (L). The length direction (L), the width direction (W) and the height direction (H) are perpendicular to one another. The end walls 12 are spaced apart from each other along the length direction (L) and are connected to the side walls 11. Each of the end walls 12 includes a first retainer member 121 extending outwardly. The end walls 12 and the side walls 11 surround the accommodating slots 100. The top wall unit 13 is connected among the side walls 11 and the end walls 12, and is divided by the notch 101 into two top walls 131. Except for the fourth accommodating slot 100, the open top end of each of the remaining accommodating slots 100 is formed in the top wall unit 13. The connection wall 14 extends along the width direction (W), is lower than the top wall unit 13 along the height direction (H), and is connected to the side walls 11. The open top end of the fourth accommodating slot 100 is formed between the top walls 131 of the top wall unit 13 and is in spatial communication with the notch 101.

The first resilient fastening members 15 are disposed in the notch 101, are spaced apart from each other along the width direction (W), are connected integrally to the connection wall 14, and extend upwardly from the connection wall 14 along the height direction (H). Each of the first fastening members 15 has a fixed end 151 connected to the connection wall 14, a free end 152 disposed opposite to the fixed end 151 along the height direction (H), and a retaining portion 153 formed between the fixed end 151 and the free end 152.

The free end 152 of each of the first fastening members 15 has a guiding inclined surface 154 extending upwardly and outwardly and adapted to guide the reaction tube 94 to be snapped into the fourth accommodating slot 100. The retaining portion 153 extends into the fourth accommodating slot 100, retains the reaction tube 94 in the fourth accommodating slot 100, and is pushable away from the axis (X) of the fourth accommodating slot 100 to move resiliently in the fourth accommodating slot 100 so as to allow mounting and removal of the reaction tube 94 from the fourth slot 100.

In one embodiment, the cartridge main body 1 is made of light transmissive material such as plastic and is integrally formed so that the accommodating slots 100 are visible from the exterior of the cartridge main body 1.

When the reaction tube 94 is accommodated in the fourth accommodation slot 100, an upper end of the reaction tube 94 is located in the notch 101. At this time, the retaining portions 153 of the first fastening members 15 block and retain the reaction tube 94 in the fourth accommodation slot 100. In other embodiments, the number of the first resilient fastening members 15 may be one or more than three, and the effect of retaining the reaction tube 94 in the fourth accommodation slot 100 can also be achieved.

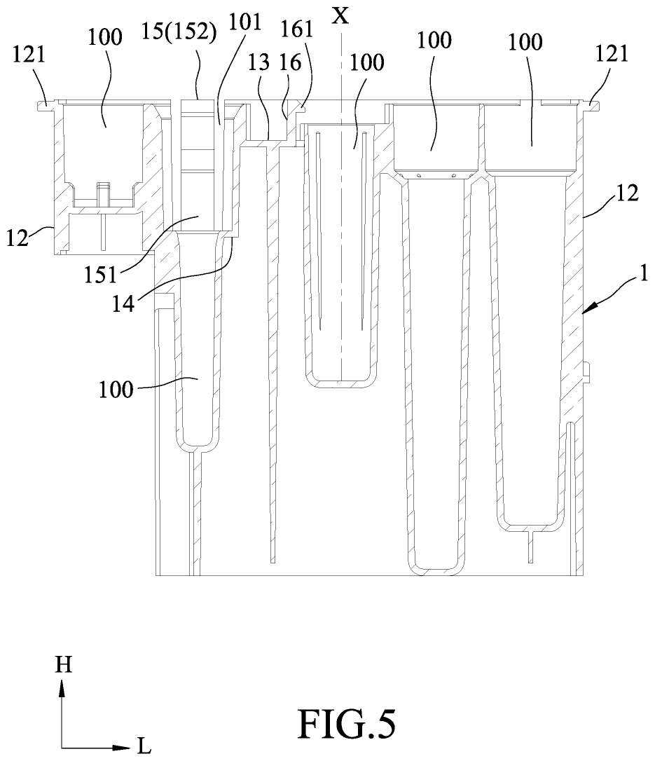

Referring to FIGS. 3 and 5, the second resilient fastening member 16 is disposed in the third accommodating slot 100, is connected integrally to and extends upwardly from one of the top walls 131 of the top wall unit 13 along the height direction (H), and includes a retaining portion 161. The retaining portion 161 is pushable to move resiliently in the third accommodating slots 100 to allow mounting of the reagent tube 93. Further, the retaining portion 161 of the second resilient fastening member 16 retains the reagent tube 93 in the third accommodating slot 100.

Referring back to FIGS. 1 to 3, the cover body 2 detachably engaging the cartridge main body 1 includes a base wall 21, a surrounding wall 22 extending from the base wall 21 toward the cartridge main body 1. In one embodiment, the cover body 2 is made of a light transmissive material such as plastic and is integrally formed. The base wall 21 includes two positioning protrusions 211 disposed opposite to each other along the length direction (L) and protruding upwardly along the height direction (H) to disable operation of the bioreactor (will be described later), and two force-exerting portions 212 spaced apart from each other along the length direction (L), protruding outwardly of the cartridge main body 1, and to be operated to allow detachment of the cover body 2 from the cartridge main body 1. The surrounding wall 22 includes two second retainer members 221 formed on an inner surface of the surrounding wall 22, extending inwardly, and engaging the first retainer members 121 of the end walls 12 of the cartridge main body 1, so that the cover body 2 is retained on the main body 1. It is required to remove the cover body 2 before the cartridge of the present disclosure is placed into the bioreactor, i.e., only the cartridge main body 1 and the objects 91 to 95 are placed into the bioreactor for performing biochemical reaction. For this, a user may exert force on one of the force-exerting portions 212 so as to remove the cover body 2. In a case that the user forgets to remove the cover body 2, and places the cartridge into the bioreactor, the positioning protrusions 211 disable operation of the bioreactor. In this way, a foolproof effect is provided. Additionally, when removes the cartridge main body 1 from the bioreactor and then mounts the cover body 2 onto the cartridge main body 1 to discard the entire cartridge so as to prevent the consumables disposed in the cartridge main body 1 from polluting the environment.

It should be stated that the objects to be disposed in the accommodating slots 100 have different configurations, and the accommodating slots 100 have different profiles and respectively and entirely receive the objects therein. The profile of each of the accommodating slots 100 is the depth, the solid angle, the diameter, etc. of the accommodating slot 100.

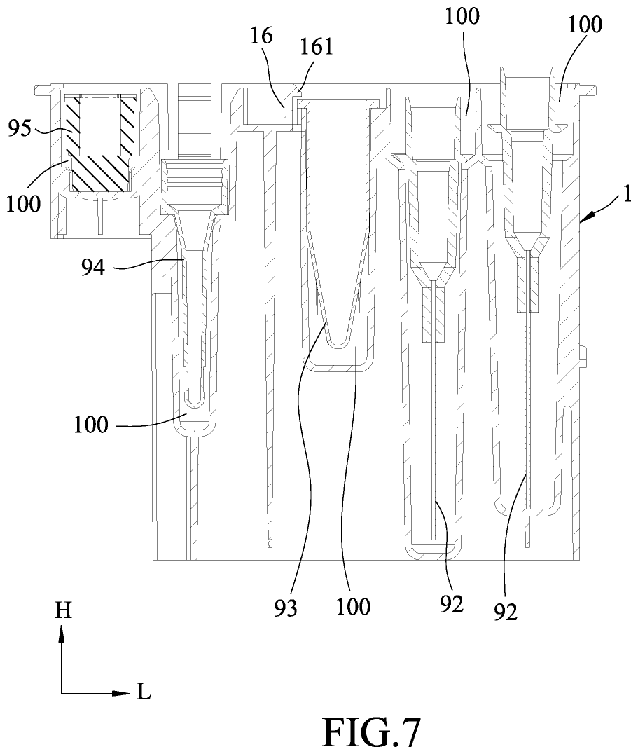

Specifically, each of the accommodating slots 100 (i.e., the first, second, and fifth accommodating slots 100) that do not hold the retaining portions 153, 161 has a profile different from that of each of adjacent ones of the accommodating slots 100, and configured such that when one of the objects 91-95 complementary in shape with any adjacent one of the accommodating slots 100 is placed into a corresponding one of the accommodating slots 100, a portion of the one of the objects 91-95 is exposed outwardly. For example, as shown in FIG. 7, when the steel needle 92 is misplaced into the first accommodating slot 100, a top end of the steel needle 92 is exposed outwardly of the first accommodating slot 100. In this way, when one of the objects is placed into one of the accommodating slots 100 that is not complementary in shape therewith, the cover body 2 cannot be mounted to the cartridge main body 1 properly. Thus, the objects can be prevented from being disposed in the wrong accommodating slots 100 during assembly of the objects into the cartridge main body 1.

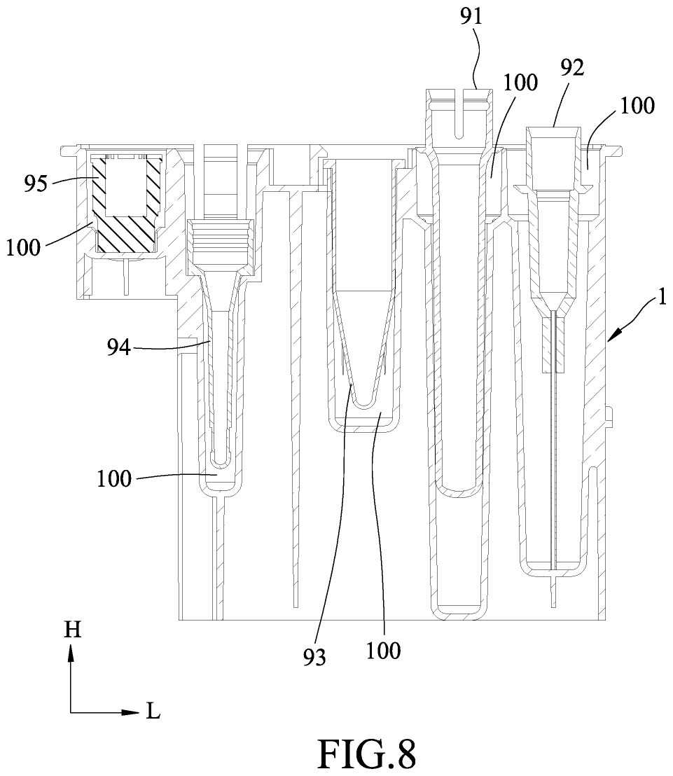

Referring to FIG. 7, an example of a steel needle 92 being misplaced into the first accommodating slot 100 is shown. The misplaced steel needle 92 has a head portion exposed outwardly from the first accommodating slot 100. As such, an assembler cannot mount the cover body 2 onto the cartridge main body 1 during assembly of the cartridge. It can be appreciated that, as shown in FIG. 8, the remaining accommodating slots 100 are designed in the same manner as above. A portion of the second accommodating slot 100 has a diameter smaller than an outer diameter of a portion of the stirring sleeve 91. When the stirring sleeve 91 is misplaced in the second accommodating slot 100, a portion of the stirring sleeve 91 is exposed outwardly of the second accommodating slot 100. Thus, the assembler is able to be easily aware of misplacement of the objects.

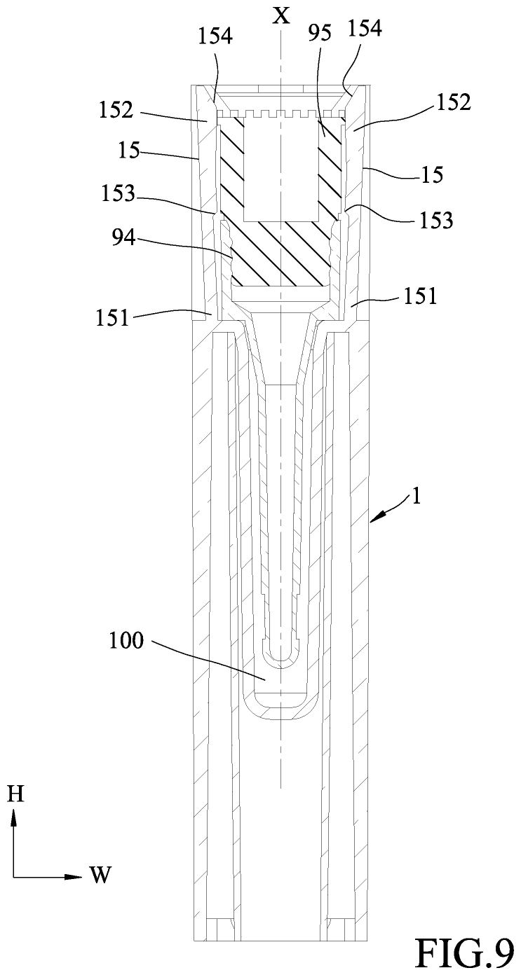

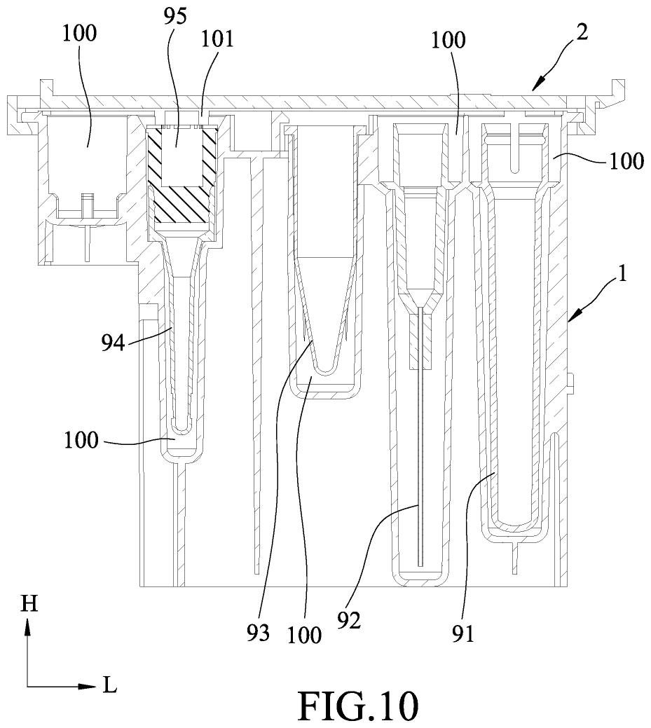

Referring to FIGS. 3, 9 and 10, the operation for using the cartridge of the present disclosure is described in the following. First, the cover body 2 is removed from the cartridge main body 1, and the cartridge main body 1 is placed into the bioreactor. The movable gripping head of the bioreactor sequentially grips the stirring sleeve 91 and the steel needle 92, and transfers polymerase chain reaction premix solutions by the steel needle 92 into the reaction tube 94. Then, the movable gripping head removes the test tube cover 95 from the fifth accommodating slot 100 and brings the test tube cover 95 into the fourth accommodating slot 100 through the notch 101 so as to be connected to the reaction tube 94 to form an object assembly. At this time, the test tube cover 95 pushes the retaining portions 153 away from the axis (X) of the fourth accommodating slot 100 so that the distance between the retaining portions 153 is increased to allow removal of the object assembly from the fourth accommodating slot 100 by using the movable gripping head. Then, the object assembly is transferred by the gripping head to another position for performing polymerase chain reaction. When polymerase chain reaction is completed in the bioreactor, as shown in FIG. 10, except for the test tube cover 95, the remaining objects are respectively moved back into the accommodating slots 100. The user then takes the cartridge main body 1 out of the bioreactor and connects the cover body 2 onto cartridge main body 1 to discard the entire cartridge.

In the procedure of the movable gripping head transferring the polymerase chain reaction premix solution into the reaction tube 94 by the steel needle 92, the reaction tube 94 is retained in the fourth accommodating slot 100 by the first resilient fastening members 15, thereby preventing the reaction tube 94 from being removed from the fourth accommodating slot 100 due to contact of the steel needle 92 with an inner surface of the reaction tube 94 resulting from deviation of the steel needle 92 when the steel needle 92 moves into and then out of the fourth accommodating slot 100. In addition, a pre-formulated reagent pellet (A) is disposed in the reagent tube 93, and a plastic sealing film (not shown) is disposed on top of the reagent tube 93 to cover the reagent tube 93. The steel needle 92 is brought to penetrate through the plastic sealing film into the reagent tube 93 by the movable gripping head and injects a solvent to dissolve the pre-formulated reagent pellet (A) so as to obtain the polymerase chain reaction premix solutions.

The retaining portion 161 of the second resilient fastening member 16 is utilized to retain the reagent tube 93 in the third accommodating slot 100 and to prevent the reagent tube 93 from being moved along with the steel needle 92 and removed accidently from the third accommodating slot 100 during a removal process of the steel needle 92 from the reagent tube 93. It can be appreciated that the number of the first and second resilient fastening members 15, 16 and the positions of the same can be modified to be suitable for use with different kinds of objects for different purpose as long as the objects respectively disposed in the accommodating slots can be retained by the first and second resilient fastening members 15, 16. It should be stated that the guiding inclined surface 154 of the first resilient fastening member 15 guides the test tube cover 95 to enter the notch 101 and then the test tube cover 95 can be snapped into and be connected with the reaction tube 94.

In other embodiments, the cover body 2 may be omitted, and the cartridge main body 1 is disposed in a packaging bag (not shown) that is complementary in shape with the cartridge main body 1. Alternatively, a sealing film/cover is attached on top of the cartridge main body 1 to ensure that all the objects 91 to 95 are accommodated respectively in accommodating slots 100 before the cartridge main body 1 is placed into the bioreactor.

To sum up, the first and second resilient fastening members 15, 16 of the cartridge for a bioreactor of the present disclosure block and retain the objects in their respective accommodating slots 100 so as to avoid making mistakes in accidental removal of the objects from the accommodating slots 100. Additionally, by virtue of the characteristic of the first resilient fastening members 15 being pushable, the test tube cover 95 can be brought to enter the notch 101 and then pushes the retaining portions 153 away from each other so as to be connected with the reaction tube 94. The retaining portions 153 are pushed away from each other by the test tube cover 95 so that a distance between the retaining portions 153 is increased. Thus, the gripping head is able to remove the object assembly including the reaction tube 94 and the test tube cover 95 from the fourth accommodating slot 100 without being obstructed by the retaining portions 153 and to transfer the object assembly to another position for subsequent processing.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A cartridge for a bioreactor adapted for accommodating a plurality of objects therein, comprising:
a cartridge main body having a top end and defining a plurality of accommodating slots that are spaced apart from one another and that are adapted for accommodating respectively the objects therein, each of said accommodating slots having an open top end and extending along a height direction, said cartridge main body including at least one resilient fastening member which extends along the height direction and which includes a retaining portion that extends into one of said accommodating slots, and that is adapted to retain a corresponding one of the objects in a corresponding one of said accommodating slots, and that is pushable to move resiliently in the corresponding one of said accommodating slots.

2. The cartridge for a bioreactor as claimed in claim 1, wherein said cartridge main body defines a notch at said top end thereof, said cartridge main body further including two side walls spaced apart from each other along a width direction transverse to the height direction, two end walls spaced apart from each other along a length direction transverse to the width direction and the height direction, a top wall unit connected among said side walls and said end walls, and a connection wall lower than said top wall unit along the height direction and connected to said side walls, said open top end of at least one of said accommodating slots being formed in said top wall unit, said top wall unit being divided by said notch into two top walls, said open top end of another one of said accommodating slots being formed between said top walls of said top wall unit and in spatial communication with said notch, said at least one resilient fastening member being connected integrally to said connection wall and disposed in said notch.

3. The cartridge for a bioreactor as claimed in claim 1, wherein said cartridge main body defines a notch in spatial communication with one of said accommodating slots, said cartridge main body further including two side walls spaced apart from each other along a width direction transverse to the height direction, two end walls spaced apart from each other along a length direction transverse to the width direction and the height direction, a top wall unit connected among said side n walls and said end walls, and a connection wall lower than said top wall unit along the height direction and connected to said main walls, said open top end of at least one of said accommodating slots being formed between said top walls of said top wall unit, said top wall unit being divided by said notch into two top walls, said cartridge main body including three of said resilient fastening members that include two first fastening members and one second fastening member, said first fastening members being spaced apart from each other along the width direction, being connected integrally to said connection wall, and extending upwardly from said connection wall along the height direction, said second fastening member being connected integrally to and extending upwardly from one of said top walls of said top wall unit along the height direction.

4. The cartridge for a bioreactor as claimed in claim 3, wherein each of said first fastening members has a fixed end and a free end disposed opposite to each other along the height direction, said fixed end being connected to said connection wall, for each of said first fastening members, said retaining portion being formed between said fixed end and said free end.

5. The cartridge for a bioreactor as claimed in claim 4, wherein said free end of each of said first fastening members has a guiding inclined surface extending upwardly and outwardly and adapted to guide one of the objects to be snapped into the respective one of said accommodating slots.

6. The cartridge for a bioreactor as claimed in claim 1, the objects having different configurations, wherein said accommodating slots defined by said cartridge main body have different profiles and are adapted to respectively and entirely receive the objects.

7. The cartridge for a bioreactor as claimed in claim 1, further comprising a cover body detachably connected to said cartridge main body for covering said accommodating slots, said cover body including at least one positioning protrusion protruding upwardly along the height direction and adapted to disable operation of the bioreactor.

8. The cartridge for a bioreactor as claimed in claim 7, wherein said cover body further includes a force-exerting portion protruding outwardly of said cartridge main body, said force-exerting portion being adapted to be operated to allow detachment of said cover body from said cartridge main body.

9. The cartridge for a bioreactor as claimed in claim 1, wherein each of said accommodating slots surrounds an axis, said retaining portion being pushable away from the axis of one of said accommodating slots in which the corresponding one of the objects being retained by said retaining portion is accommodated, so as to allow mounting and removal of the corresponding one of said objects.

10. A cartridge for a bioreactor, comprising:
a cartridge main body having a top end and defining a plurality of accommodating slots that are spaced apart from one another, each of said accommodating slots having an open top end and extending along a height direction, said cartridge main body including at least one resilient fastening member extending along the height direction and including a retaining portion extending into one of said accommodating slots; and
a plurality of objects respectively and detachably accommodated in said accommodating slots, said retaining portion of said at least one resilient fastening member retaining a corresponding one of said objects to be accommodated in a corresponding one of said accommodating slots, and being pushable to move resiliently in the corresponding one of said accommodating slots.

11. The cartridge for a bioreactor as claimed in claim 10, wherein each of said accommodating slots that do not receive said retaining portion has a profile different from that of each of said remaining accommodating slots, and configured such that when one of said objects complementary in shape with any adjacent one of said accommodating slots is placed thereinto, a portion of the one of said objects is exposed outwardly therefrom.

12. The cartridge for a bioreactor as claimed in claim 10, wherein each of said accommodating slots surrounds an axis, said retaining portion being pushable away from the axis of one of said accommodating slots in which the corresponding one of said objects being retained by said retaining portion is accommodated, so as to allow mounting and removal of the corresponding one of said objects.

13. The cartridge for a bioreactor as claimed in claim 10, wherein each of said accommodating slots surrounds an axis, one of said objects other than the one of said objects retained by said retaining portion being operable to be removed from the corresponding one of said accommodating slots, and to be then brought to push said retaining portion away from the axis of the one of said accommodating slots that accommodates one of said objects retained by said retaining portion, so as to connect with one of said objects retained by said retaining portion to form an object assembly, which is removable from the corresponding one of said accommodating slots.
